(19) United States
(12) Patent Application Publication
(10) Pub. No.: US 2026/0300876 A1
(43) Pub. Date: Oct. 1, 2026

(54) DUAL PROTOCOL PRE-TRADE AND POST-TRADE RISK MANAGEMENT SYSTEM AND METHOD

(71) Applicant: Bull Teknoloji, Istanbul (TR)

(72) Inventors: ALI VOLKAN ATLI, Istanbul (TR); MUCAHIT UCER, Istanbul (TR); YAKUP YILDIZ, Istanbul (TR); ELIF GAYRETLI, Istanbul (TR); ADHAMZHON SHUKUROV, Istanbul (TR); FATIH KUCUK, Istanbul (TR); SAVAS SASMAZ, Istanbul (TR); YILMAZ GURAK, Istanbul (TR); MUHAMMET ERDEM, Istanbul (TR)

(21) Appl. No.: 19/094,687

(22) Filed: Mar. 28, 2025

(51) Int. Cl. G06Q 10/0635; G06Q 40/04

(52) U.S. Cl. CPC G06Q 10/0635; G06Q 40/04

(57) ABSTRACT

A system and methods are implemented for ultra-low latency pre-trade and non-real-time post-trade risk checks between a high-frequency trader (HFT) and an exchange. The system employs a mechanism to receive a copy (‘clone’) of the order message generated by the HFT using a first messaging protocol, while the order message is being transmitted to the exchange. The cloned order message is then analyzed by a deep packet inspector to assess if it passes risk checks. If the clone does not pass the risk checks, the system generates an order cancellation request on behalf of the HFT and sends it to the exchange using a second messaging protocol. This cancellation request is uniquely linked to the original order using an exchange-generated Order ID.

### TECHNICAL FIELD

The present invention generally relates to the field of electronic trading in financial markets. More specifically, the present invention is related to a dual-stage system performing ultra-low latency pre-trade risk management and integrated post-trade risk analysis.

### DEFINITIONS

A “security” refers to a stock, bond, and a derivative product such as option, future, etc. that is subject to buy and sell transactions in the securities market.
“SEC” Securities and Exchange Commission (SEC) is a U.S. federal regulatory agency responsible for overseeing the securities market.
“Exchange” is a place where securities are Exchanged. It acts as an intermediary so that securities issued by all traders can be listed and traded through buy and sell orders. Within this context, the term ‘Exchange’ refers to one or more electronic systems that perform trading.
An “Order” is a buy or sell trade instruction or message that includes information such as trader identifier, order token, order type, price, quantity, buy or sell direction and symbol.
The term (HFT) stands for High-frequency Trader who employs advanced algorithms and high-speed computers systems, including CPUs, GPUs, FPGAs, and ASICs, to execute a large volume of orders rapidly. The terms HFT and algorithmic trading are often used inter-changeably.
The term “PTRM” stands for pre-trade risk management that involves actions required for managing and mitigating risk associated with an order. It involves setting trade risk limits, checking orders against risk limits and rejecting those that exceed them, and continuous monitoring of trader's activities to manage risks.
The term ‘Limit Order Book’ (LOB) which is used interchangeably with order book (OB) is a listing of all current orders that are in the exchange but not fulfilled yet. The LOB includes buy and sell limit orders, which are typically sorted by price and time priority, but may also be organized using alternative mechanisms such as pro-rata or size priority depending on the market structure.
“Matching engine” is the software program that forms the heart of an electronic Exchange that matches buy and sell orders on a continuous basis to fulfill trades according to a ruleset. Historically, this function was carried out manually by trading floor professionals in physical exchanges, but modern matching engines operate entirely electronically, utilizing software or high-performance hardware solutions such as FPGA or ASIC to meet the demands of ultra-low latency and high-throughput trading.
‘Field Programmable Gate Array’ (FPGA) is a type of integrated circuit that can be customized for a particular operation. Through parallel processing, it achieves low latency and high performance in processing data.
“OUCH” protocol is short for “Order Update and Cancellation History”. It encodes order messages from a trader such as ‘enter order’, ‘cancel order’, and ‘modify order’. It also encodes responses from the exchange such as ‘order accepted’, ‘order executed’, ‘order rejected’and ‘order cancelled’.
The ITCH is short for ‘Intra-Trade Communication Handler’. It is a broadcast protocol used for disseminating detailed, full-depth, order-level market data messages with ultra-low latency.
‘FIX’ protocol is short for “Financial Information Exchange”. Like OUCH, it is a messaging protocol between an Exchange and traders.
“TAP” refers to a ‘test access point’ that is a hardware device that monitors network traffic without interfering with the normal flow of data. It's like a passive listener on the network, capturing packets as they pass by, and, if needed, duplicating the traffic for analysis by external monitoring tools such as intrusion detection systems, performance analyzers, or risk management systems.

### BACKGROUND OF THE INVENTION

Pre-Trade Risk Management (PTRM) is a regulatory process wherein a sponsoring broker acting as a middleman can set various constraints on trade orders and provide tools to control the trading activity of their member traders for prevention of potentially erroneous transactions. A sponsoring broker is a regulated financial institution that provides direct market access to their clients including HFTs. In 2010, SEC put new controls to enable sponsoring brokers not to trade over an allowed limit, and their member HFTs and other traders not to submit erroneous orders into the market. Such orders can cause a dangerous wide scale market disruption that may present a financial risk to the exchange and other traders. Commonly known as SEC directive 15c3-3, and implemented in the US, several types of controls are specified and mandated on sponsoring brokers to mitigate pre-trade and post-trade risks associated with orders. It is designed to protect traders by requiring the sponsoring broker to safeguard trader's funds and securities. While the implementation of this rule is primarily focused on U.S. brokers, similar regulations, such as MiFID II in the European Union, exist globally to protect investors and maintain market stability.

Pre-trade risk checks can introduce additional latency to order execution, as they require processing before the order can be submitted to the exchange, potentially impacting its competitiveness. The specific checks performed varies depending on the exchange, the country and the PTRM system in use. Common pre-trade checks include: (i) Order validation: ensuring the order message's format and syntax are correct, (ii) User and account verification: confirming the submitter's eligibility. (iii) Security eligibility: verifying if the security can be traded by the submitter. (iv) Order type and quantity validation: checking if the order type and quantity are permissible. (v) Price validation: checking if the order price is within a plus/minus current price range. An order must first pass all these checks to be considered valid.

The latency for order execution in a matching engine can vary depending on several factors. Market orders are typically executed rapidly, while limit orders may wait in the order book until a matching order arrives. During periods of high volatility or heavy trading volume, all execution times may be much longer. The speed and efficiency of the exchange's matching engine and network infrastructure can also impact execution times. Generally, order execution times are measured in milliseconds and even microseconds. During this time window, an order can be cancelled or replaced. Thus, pre-trade checks must be performed in a small fraction of these execution times.

Post-trade risk checks are performed after the order is validated and entered the Limit Order Book (LOB). These checks are more sophisticated and rely on accumulated trade counts over a specific period. If a trade order fails a post-order risk check, in some instances it may still be possible to cancel the trade if it has not yet been executed by the matching engine. An order's presence within the current limit order book (LOB) signifies that it has not yet undergone execution. A failure of a post-order risk check could cause certain future orders to be rejected and/or cause the HFT to change or revise its future trading strategy. Because more comprehensive and computationally expensive risk checks are required, they are performed, after the pre-trade checks, by a separate software subsystem. Exemplary checks are (i) Total quantity checks of the trader over a period, (ii) Checks on credit limits of the trader, and (iii) Monitoring if the total position limits and margin requirements are within a specific timeframe to prevent excessive risk accumulation.

Post-trade risk management systems are usually slower as they need to access and process market data, historical order data, and PTRM thresholds from various sources. This can be time-consuming, especially if the data is not efficiently stored or indexed. The breaches and warning levels of these checks cause a notification to the HFT in the form of a message, and/or an entry within a report prepared by PTRM system's user interface for the HFT.

Contrary to post-trade risk analysis, pre-trade order verification and validation processes are extremely latency sensitive and must be completed before an order reaches the matching engine for execution.

There are several references for pre-trade risk management systems varying from purely software-based systems to programmable hardware based faster solutions providing millisecond to nanosecond latency range. Early-generation systems, typically software-based and deployed at sponsoring broker sites, intercepted all orders, parsed their content, and subjected them to pre-trade risk checks using parameters configured in the broker's risk management system. Only orders deemed compliant were forwarded to the exchange for execution. These systems were inefficient. A significant latency is involved in software-based systems due to internal communications between the components of the computer hosting the software through an internal bus. However, whether the delay occurs in reading the order message, analyzing current risk or in sending orders to the exchange, the impact is that the overall combined latency of all these functions is increased while each component related to a specific function seeks to communicate with another component within the computer system. This problem is further exacerbated by the need to parse each order message.

Newer approaches involved the deployment of packet sniffing devices to capture and analyze order messages. They divert captured packets of order messages to a deep packet inspector (DPI) typically through TAP (Test Access Point) devices or SPAN ports. The DPI dissected the packet content, extracting details such as order type, price, quantity, side, and symbol. Pre-trade risk checks were then applied to the parsed order message content. This process was accelerated by utilizing specialized hardware, minimizing latency and ensuring timely order processing. Typically, those pre-trade parameters that are checked for violations were configured to the system by the HFT through either a Graphical User Interface (GUI) or an Application Programming Interface (API).

As the first example, U.S. Pat. No. 10,489,857 discloses a method that uses packet sniffer to proactively identify and neutralize erroneous order messages by strategically corrupting the final bytes of the invalid order message. Doing so, the system prevents the order's acceptance by the exchange.

As the second example, US Published Patent Application 2011/0166982 A1 discloses a method that uses packet sniffer to identify pre-trade violations. When a violation is detected, the system initiates a communication disruption, either physically or logically, between the HFT and the exchange. This action triggers a ‘cancel-on-disconnect’ process at the exchange, resulting in the cancellation of the new order along with all pending orders of the HFT. While effective in preventing further risk, this approach lacks the granularity to selectively cancel individual orders.

As the third example, US Published Patent Application 2010/0094743 A1 employs a packet sniffer to detect pre-trade violations. When an invalid order containing pre-trade violations is detected, the system silently deletes the message without notifying the HFT. To prevent message sequence number mismatches between the HFT and the exchange because of deleted message, the system recalculates and adjusts the sequence numbers of subsequent order messages. As an alternative approach, the system sends a non-trade message, such as a ‘heartbeat message’, to the exchange to add a message. This non-trade message increments the exchange's sequence number, effectively replacing the sequence number of the discarded order. Subsequent order messages can then use the adjusted sequence numbers. In addition to added processing, an important shortcoming of this method is that the HFT does not know that the order message was erroneous and deleted.

Packet sniffer solutions, which employ techniques like corrupting messages, terminating connections, or deleting messages have inherent limitations. These tactics can trigger unintended consequences, such as the exchange disconnecting the HFT's entire trading session and initiating a cancel-on-disconnect process, resulting in the cancellation of all pending orders. This can disrupt the HFT's trading operations and hinder their ability to execute trades. The termination of a trading session could leave orders stranded in the market, unable to respond to rapidly changing market conditions, which can result in severe financial losses. In such scenarios, the market's Limit Order Book (LOB) continues to move, but the HFT's orders remain static, creating a mismatch that disrupts the trader's strategy and increases exposure to risk. These limitations underscore the critical need for more reliable and non-invasive risk management solutions that maintain market stability while avoiding operational disruptions.

Prior art packet sniffer solutions primarily focus on capturing and analyzing outgoing HFT order messages, neglecting incoming acknowledgments about order status and real-time order book data. This limitation restricts their ability to track the status of order executions and perform comprehensive post-trade risk calculations to become compliant with all SEC regulations.

As a different approach, US Published Patent Application 2022/0076336 A1 integrates a Field Programmable Gate Array (FPGA)-based system within each HFT to perform pre-trade risk checks locally prior to order transmission to the exchange. The PTRM configuration is directly programmed into the HFT's software. While this approach offers a logical solution to prevent violations at the root, it incurs significant costs due to the requirement of a dedicated PTRM system per HFT. Furthermore, it necessitates software modifications and integration efforts within each HFT's trading system. Any changes to the PTRM components would require updates to all HFT trading systems. These systems do not perform post-trade risk checks.

References [see NASDAQ NORDIC Genium INET Pre-Trade Risk Management Service Guide 2.2, Pre-Trade Risk Management in Derivatives Market (slide presentation), and PTRM API version 1.1.3] outline Exchange-based PTRM solutions that rely on software to enforce pre-trade checks before orders entering the LOB. Traders configure their specific risk parameters through a GUI or API. While these solutions can effectively manage risks for individual investors, they are often too slow to accommodate the high-speed and high-volume trading requirements of HFTs. Additionally, these systems are typically limited to checking orders destined for a specific Exchange as they are implemented within the exchange, making them insufficient for HFTs that trade across multiple Exchanges that require comprehensive risk management, including checks on aggregated order executions by several Exchanges.

Given the limitations of existing solutions, a new system is needed to meet the PTRM requirements of HFTs. Instead of resorting to disruptive tactics like corrupting messages, changing message sequence numbers or terminating sessions, the system of invention rapidly cancels an invalid order on behalf of the HFT. To achieve this operation, the invention leverages a test access point (TAP) device and a programmable hardware implementing a deep packet inspector. Valid order message transmission experiences no delays while invalid order cancellations are executed with minimal latency.

TAP or Switch Port Analyzer (SPAN) solutions are commonly used to monitor network traffic by duplicating data streams for analysis. A TAP device utilizes optical-signal splitting to create an exact duplicate of incoming network traffic, while the original data continues to its intended destination unaltered. This process, known as cloning, ensures non-intrusive monitoring. In contrast, a SPAN mirrors traffic through a network switch and can introduce potential packet loss or latency under heavy loads due to its shared resources with the network switch. Unlike SPAN ports, which are bidirectional, TAPs operate unidirectionally and do not transmit any data back onto the network.

To monitor network traffic bi-directionally (i.e., from the HFT to the exchange and vice versa), two TAP connections are required. This can be achieved using either two single-direction TAP devices, or a dual-direction TAP capable of monitoring both directions simultaneously. For clarity, the embodiments in this document depict the use of two TAP devices. However, the system supports alternative configurations, including aggregation TAPs that consolidate multiple data streams into one for analysis or regeneration TAPs that duplicate traffic to multiple destinations for parallel monitoring. Based on the analysis of a cloned order message, the system of invention rapidly generates an order cancellation request for a risky (or invalid) order by acting on behalf of the HFT. The system ensures that the order cancellation requests reach the order book before the matching engine executes the trades by performing this task in a few hundred nanoseconds.

Embodiments of the present invention are an improvement over prior art systems and methods.

### SUMMARY OF THE INVENTION

In one embodiment, the present invention provides An article of manufacture having non-transitory computer readable storage medium comprising computer readable program code executable by one or more processors to perform pre-trade or post-trade risk checks, the medium comprising: (a) computer readable program code receiving a cloned order message on a first communications interface via a first messaging protocol during its transmission, the cloned order message generated by cloning an order message received from a high-frequency trading (HFT) system and destined for an exchange; (b) computer readable program code extracting one or more content fields from the cloned order message; (c) computer readable program code receiving a plurality of risk parameters associated with the HFT, and a current Limit Order Book (LOB) sent via a third messaging protocol, the plurality of risk parameters and the LOB received from one or more datastores; (d) computer readable program code comparing the one or more content fields of the cloned order message with the plurality of risk parameters and the current LOB and performing one or more risk checks; (e) computer readable program code, upon failing at least one of the one or more risk checks, generating, on behalf of the HFT, an order cancellation request message in a second messaging protocol; and (f) computer readable program code sending the order cancelation message in the second messaging protocol to the exchange over a second communications interface.

In one embodiment, the medium further comprises computer readable program code, in (e), extracting an Order ID, a unique identifier for the order to be cancelled in the order cancellation request message, received using the first messaging protocol from a cloned response message to the order cancellation request message generated by the exchange.

In one embodiment, the medium further comprises computer readable program code receiving, using the second messaging protocol, a first confirmation for the order cancellation request message, wherein the HFT also receives, using the first messaging protocol, a second confirmation for the order cancellation request message.

In one embodiment, the medium further comprises computer readable program code receiving over a third communication interface, a copy of all messages generated by the exchange using the third messaging protocol and the first messaging protocol.

In one embodiment, the third messaging protocol is a market data feed protocol providing market data information to one or more subscribers, wherein market data comprises details about all orders, trades, or market events.

In one embodiment, the first messaging protocol is a two-way order entry protocol for high-speed order management used to send orders to the exchange and receive execution updates, wherein the first messaging protocol is used to: submit new orders. replace existing orders, cancel orders, or receive execution reports.

In one embodiment, the first messaging protocol is Order Update and Cancellation History (OUCH).

In one embodiment, the second messaging protocol is Financial Information eXchange (FIX).

In one embodiment, the second messaging protocol is Representational State Transfer (REST) Application Programming Interface (API) over HTTP.

In one embodiment, the third messaging protocol is Intra-Trade Communication Handler' (ITCH).

In one embodiment, the medium further comprises computer readable program code updating order status as any of the following: (a) after passing risk checks, as ‘valid’, (b) after failing pre-trade risk checks, as ‘pre-trade check failed’, (c) after failing post-trade risk checks, as ‘post-trade check failed’, (d) after sending order cancellation request message, as ‘cancel requested’, or (e) after receiving order cancellation confirmation as ‘cancellation completed’.

In one embodiment, failure of pre-trade risk checks is because of one or more of the following types of information being wrong: stock symbol, order quantity, order price, permitted stock.

In another embodiment, the present invention provides a system that performs pre-trade or post-trade risk checks, the system comprising: (a) a memory; (b) a central processing unit (CPU) implementing pre-trade risk management (PTRM) configuration management and non-real-time risk management functions; and (c) an FPGA comprising a packet processor, a LOB Handler, an order handler and fast risk management functions, and comprising the following interfaces: (i) a first communications interfaces to connect to a first test access point (TAP) device interface to receive clones of messages originating from a high-frequency trading (HFT) system using a first messaging protocol; (ii) a second communications interface to connect to an exchange to send and receive messages using a second messaging protocol; (iii) a third communications interfaces to connect to a second TAP device interface to receive clones of messages originating from the exchange using the first messaging protocol and a third messaging protocol, wherein the memory stores computer readable computer code: (1) receiving a cloned order message on the first communications interface via the first messaging protocol during its transmission, the cloned order message generated by cloning an order message received at the HFT system and destined for the exchange; (2) extracting one or more content fields from the cloned order message; (3) receiving a plurality of risk parameters associated with the HFT and a current Limit Order Book (LOB) sent via the third messaging protocol, the plurality of risk parameters and the LOB received from one or more datastores; (4) comparing the one or more content fields of the cloned order message with the plurality of risk parameters and the current LOB and performing one or more risk checks; (e) upon failing at least one of the one or more risk checks, generating, on behalf of the HFT, an order cancellation request message in the second messaging protocol; and (f) sending the order cancelation message in the second messaging protocol to the exchange over the second communications interface.

In one embodiment of the system, the memory further stores computer readable program code to extract an Order ID, a unique identifier for the order to be cancelled used in the cancellation request message, received using the first messaging protocol from the cloned response message to the order message generated by the exchange.

In one embodiment of the system, the memory further stores computer readable program code to receive, using the second messaging protocol, a first confirmation for the order cancellation request message, wherein the HFT also receives, using the first messaging protocol, a second confirmation for the order cancellation request message.

In one embodiment of the system, the memory further stores computer readable program code to receive over a third communication interface, a copy of all messages generated by the exchange using the third messaging protocol and the first messaging protocol.

In one embodiment of the system, the third messaging protocol is a market data feed protocol providing market data information to one or more subscribers, wherein market data comprises details about orders, trades, or market events.

In one embodiment of the system, the first messaging protocol is a two-way order entry protocol for high-speed order management used to send orders to the exchange and receive execution updates, wherein the first messaging protocol is used to: submit new orders. replace existing orders, cancel orders, or receive execution reports.

In one embodiment of the system, the first messaging protocol is Order Update and Cancellation History (OUCH).

In one embodiment of the system, the second messaging protocol is Financial Information eXchange (FIX).

In one embodiment of the system, the second messaging protocol is Representational State Transfer (REST) Application Programming Interface (API) over HTTP.

In one embodiment of the system, the third messaging protocol is Intra-Trade Communication Handler' (ITCH).

In one embodiment of the system, the memory further stores computer readable program code to update order status as any of the following: (a) after passing risk checks, as ‘valid’, (b) after failing pre-trade risk checks, as ‘pre-trade check failed’, (c) after failing post-trade risk checks, as ‘post-trade check failed’, (d) after sending order cancellation request message, as ‘cancel requested’, or (e) after receiving order cancellation confirmation as ‘cancellation completed’.

In one embodiment of the system, failure of pre-trade risk checks is because of one or more of the following types of information being wrong: stock symbol, order quantity, order price, permitted stock.

In one embodiment, order cancellation requests injected by the system of invention are transmitted to the exchange via a second messaging protocol when order messages are transmitted using a first messaging protocol. This dual-protocol approach prevents sequence number conflicts that could arise if the injected messages were sent through the same protocol as the original orders. By leveraging a secondary protocol, the system ensures compatibility and avoids disrupting the sequence integrity of the primary protocol while providing a robust mechanism for managing risky orders in real-time.

The HFT is allowed to declare its use of multiple protocols during registration with the exchange. This configuration option is key to enabling the HFT to utilize one protocol for its own order messages, while the system of invention (on behalf of the HFT) employing another protocol for order cancellations only. Illustrative examples of suitable protocols are OUCH [see OUCH Protocol Specification, BISTNET, Borsa Istanbul (BIST)] and FIX [see FIX Protocol Specification, FIX Trading Community, version 5], both established standards in the financial industry. However, other protocols can also be used. Exchange's response to a cancellation request will use the same protocol used in the cancellation request to adhere to industry standards (e.g., FIX confirmations for FIX cancellations).

In one embodiment, the HFT places an order using OUCH as the first (primary) messaging protocol, and the system of invention uses FIX as the second messaging protocol for risky (invalid) order cancellations. The system of invention copies the unique order number from the OUCH message into the FIX message. This consistent use of unique order numbers across protocols allows the exchange to accurately identify the order in the LOB and execute the cancellation request across protocols. In the second embodiment, the HFT places an order using OUCH as the first messaging protocol, and the system of invention uses a PTRM REST API over HTTP as the second messaging protocol.

The exchange creates an identifier for each new order known as ‘Order ID’ after receiving an ‘enter order’ message. An ‘order accepted’ message generated by the exchange signifies the successful receipt and preliminary acceptance of the order in response to the ‘enter order’. It also signifies that the order has been received and placed in the LOB for potential execution. Order acceptance does not guarantee that the order will be fulfilled. This message includes the Order ID for tracking the order status (e.g., pending, filled, canceled) or to cancel or modify orders if needed. The FIX ‘order cancel’ message must include that exchange-generated Order ID. A critical component of this implementation involves promptly generating the ‘order cancel’ FIX message after the system of invention receiving a clone of the ‘order accepted’ message, specifically after sniffing the Order ID. As an example, the exchange responds with an ‘Execution Report’ FIX message to the system of invention that originates the cancellation. In the meantime, it will send the same confirmation to the HFT that generated the original ‘enter order’ in the form of an ‘Order Status’OUCH message. Doing so, the HFT will be informed of the cancellation as well. The exact implementations and required field names may vary depending on the exchange's specific protocol version implementations and any agreed-upon extensions.

The FIX protocol has sender and target (receiver) identifiers as part of the protocol. For example, SenderCompID (Tag 49) is the field that uniquely identifies the sending entity (e.g., the system of invention). TargetCompID (Tag 56) identifies the entity intended to receive the message (e.g., the exchange). Also, OnBehalfOfCompID (Tag 115) is used as the originator of the message (i.e., the HFT) when a cancel is requested by the system of invention. In this scenario, the exchange will be configured to send the ‘Execution Report’ to the originator specified in SenderCompID, i.e., the system of invention.

The system continuously monitors all network traffic between the HFT and the exchange. This includes all message types, such as HFT's order entry and cancellation messages using the OUCH protocol, LOB updates using the ITCH protocol, and other status messages originating from the exchange. Two dedicated network connections (ports) are utilized to capture incoming and outgoing traffic using the TAP. A separate connection (port) is used exclusively for sending order cancellation requests to the exchange and receiving their confirmation responses.

The term ‘order’ is synonymous with ‘enter order’ and ‘replace order’ OUCH messages. Specific message names, fields and contents may change from one version of the protocol to another.

### BRIEF DESCRIPTION OF FIGURES

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts the block diagram showing an exchange and an HFT cabinet.

FIG. 2 depicts a first alternative PTRM system according to a prior art.

FIG. 3 depicts a second alternative PTRM system according to prior art.

FIG. 4 depicts a third alternative PTRM system according to prior art.

FIG. 5 depicts message flow according to packet sniffer of prior art.

FIG. 6a depicts transmit side (TX) message paths according to invention.

FIG. 6b depicts receive side (RX) message paths according to invention.

FIG. 7a depicts an embodiment of the system of invention showing key components.

FIG. 7b depicts connection of an embodiment of system of invention to the data center.

FIG. 8a shows a flowchart of the first method of invention for pre-trade risk analysis.

FIG. 8b shows a flowchart of the second method of invention for pre-trade risk analysis.

FIG. 8c shows a flowchart of a method of invention for post-trade risk analysis.

FIG. 9 shows an embodiment of a hardware diagram of the system of invention.

Skilled professionals will appreciate that elements in the figures are illustrated for simplicity and clarity and have not necessarily been drawn to scale. Also, common but well-understood elements that are useful or necessary in a commercially feasible embodiment are often not depicted to facilitate a less obstructed view of these various embodiments of the present invention. Flowchart and block diagrams in the figures illustrate the functionality and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DETAILED DESCRIPTION

The detailed descriptions contain explanations, formulas, diagrams, and flowcharts that are provided purely to enhance the understanding of the system components and the methods, and thus they may not describe all details or illustrate all trivial blocks and steps that would be understood by those persons skilled in art. Some of the figures are presented only for clarifying the terminology or to explain the prior art in contrast to present invention.

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

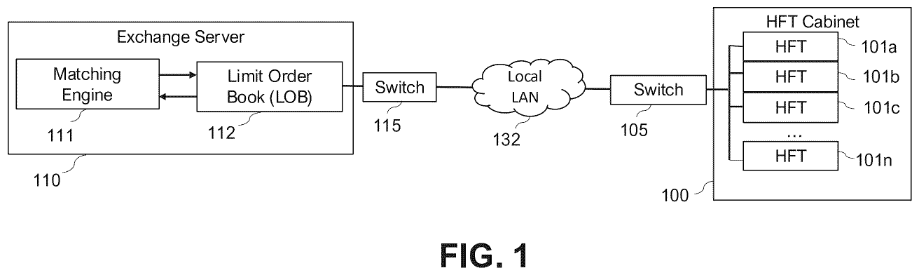

FIG. 1 depicts a typical prior art colocation configuration between Exchange Server 110 and a group of HFT Systems 101a, 101b, 101c, . . . , 101n within HFT Cabinet 100 attached to high-speed switched Local Area Network (LAN) 132 of the data center in which Exchange Server 110 is deployed. A HFT cabinet is typically used to place systems of several HFTs, and/or several servers of an HFT. Two key functions of Exchange Server 110 are shown as Matching Engine 111 and Limit Order Book (LOB) 112. Matching Engine 111 is the computer logic to matches massive number of buy and sell orders to execute trades.

Limit Order Book (LOB) 112 is a crucial component of the exchange, facilitating the buying and selling of securities. When a trader places a limit order, for example, they specify a maximum price they're willing to pay (for a buy order) or a minimum price they're willing to accept (for a sell order). These orders are then added to the order book in price and time order forming a list of all outstanding buy and sell orders.

When a trader wants to cancel an order, they send an order cancellation request to the exchange. Matching engine 111 receives the cancellation request and identifies the specific order within the LOB to be canceled and removes it from the LOB. This ensures that the order is no longer eligible for matching with other orders. The Exchange sends a cancel confirmation to the trader indicating that the order has been successfully removed from the system.

Note that there may be a plurality of Exchange Servers 110 within the same data center. Colocation with the exchange is the preferred option of connectivity for the HFTs to minimize latency in trading. LAN 132 may use multiple layers of smart Layer-2 switches connecting several HFT cabinets using switch 105 to multiple mirrored servers of Exchange Server 110, each server connected to LAN 132 via Switch 115.

Alternative to a switched LAN, a software defined network (SDN) well-known in prior art, may be providing connectivity wherein ultra-high speed intelligent forwarders are used for packet forwarding between HFTs and Exchange servers. These solutions offer alternate connectivity's within the switched LAN for the traffic management.

Another connectivity option is high-speed fiber optic Private Line between HFT Cabinet 100 and Exchange Server 110, if Cabinet 100 is remotely located. This is a direct wired connection and has the lowest latency as the traffic does not need to traverse multiple switches of the data center network. Yet another option is a leased dedicated network link from a Network Service Provider (NSP) with strict latency requirement. This invention encompasses a diverse array of network connectivity configurations, which are not explicitly enumerated herein.

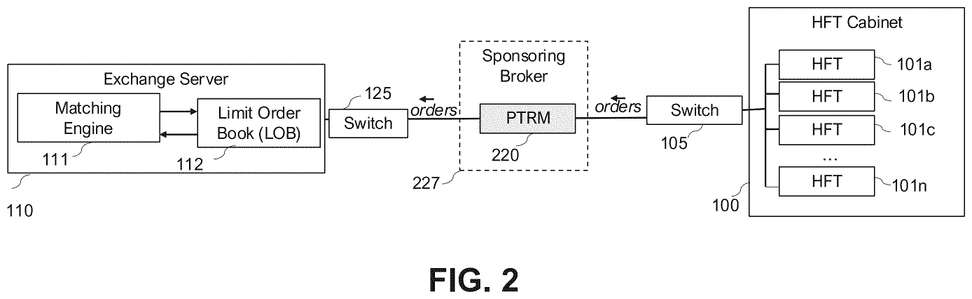

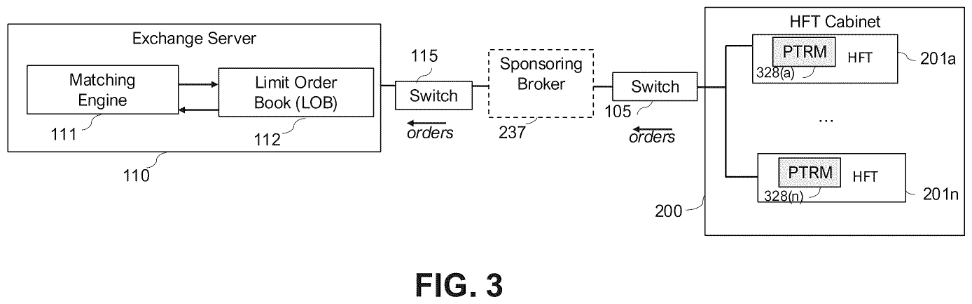

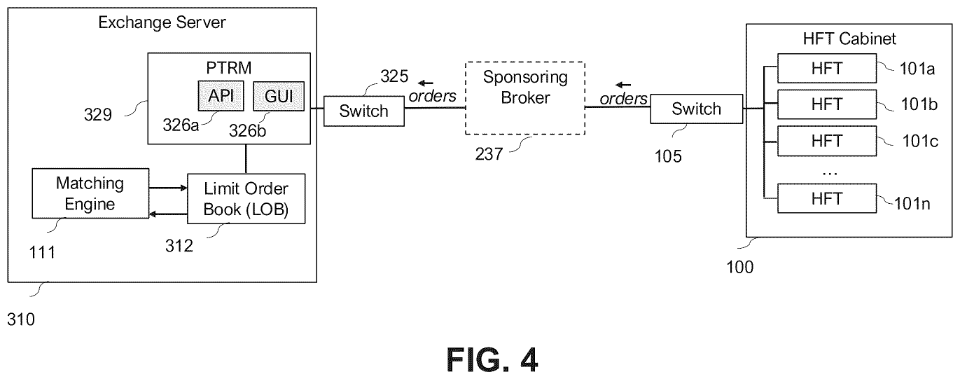

FIG. 2, FIG. 3 and FIG. 4 depict various configurations of PTRM solutions found in prior art that are detailed in the background section. Specifically, FIG. 2 shows a software-based or packet sniffing solution found in prior art through PTRM System 220 deployed at the site of Sponsoring Broker 227. This solution serves a plurality of HFTs by being in the middle between Exchange Server 110 and HFT Cabinet 100.

FIG. 3 depicts a hardware-based solution. In this configuration, PTRM Systems 328a and 328n are integrated within HFT Systems 201a and 201n, respectively, both housed within HFT Cabinet 200. Since each HFT has its dedicated PTRM system that actively monitors orders for risk compliance, a Sponsoring Broker 237 is not required to provide a separate PTRM system.

FIG. 4 illustrates yet another prior art configuration where Exchange 310 houses PTRM System 329. All incoming orders, routed through Switch 325, are first processed by PTRM System 329. Orders that pass the risk checks are forwarded to LOB 312, while others are rejected. The PTRM system provides both an API 326a and a GUI 326b for configuration of risk parameters of each trader. Since Exchange 310's PTRM system proactively monitors orders for risk compliance, a Sponsoring Broker 237 may not require a separate PTRM system. This solution is particularly well-suited for individual investors associated with Sponsoring Broker 237. However, the latency introduced by this configuration is not optimal for HFT applications.

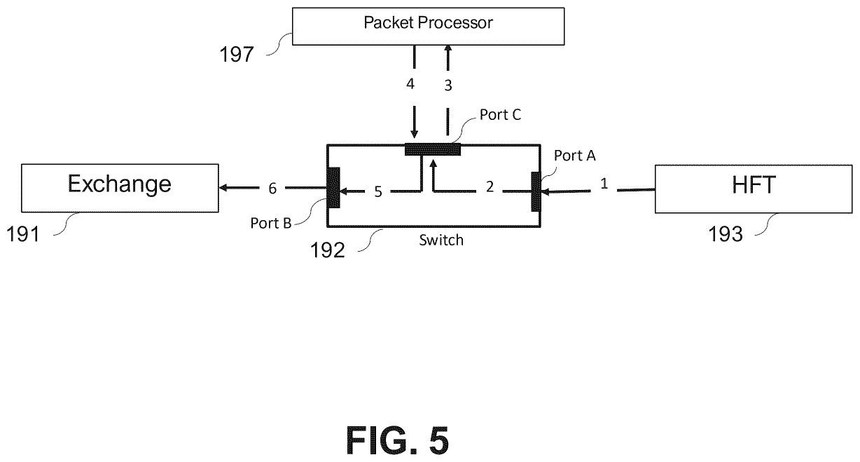

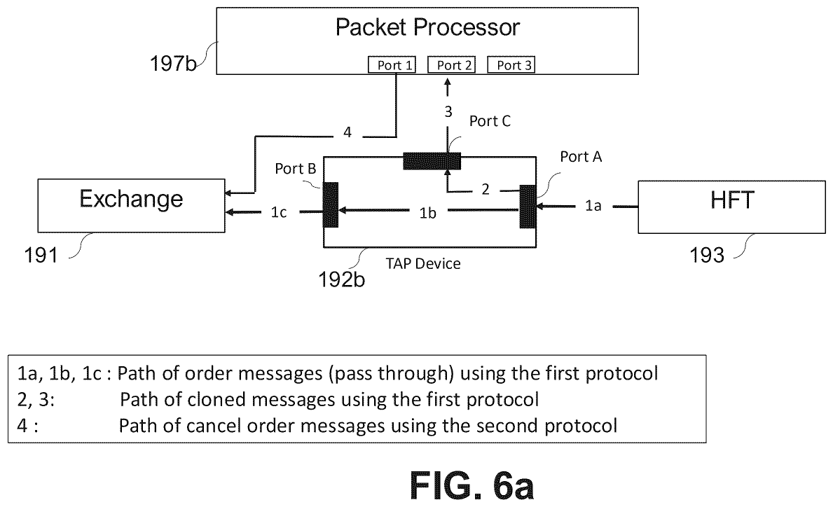

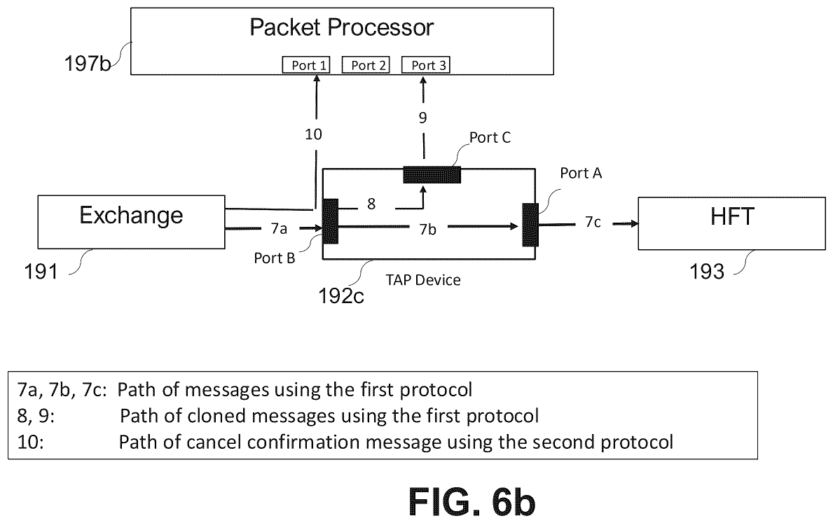

The key differences between the conventional packet sniffer solution discussed in prior art versus this invention is clarified using the simplified diagrams shown FIG. 5, FIG. 6a and FIG. 6b. FIG. 5 illustrates the conventional packet sniffer approach, where HFT order messages are intercepted by a device, such as a network switch or a specialized hardware. In one solution, the order message of HFT 193 is initially intercepted by device 192, which forwards it to Packet Processor 197. The packet processor analyzes the message's content to determine its validity. Valid messages are subsequently transmitted to Exchange 191, while invalid messages are either discarded or modified. All valid and invalid orders are subjected to this processing pipeline, introducing additional latency to valid orders.

More specifically, the order message from HFT 193 is first intercepted by Device 192 (also known as ‘packet sniffer’) at port A (step 1) in FIG. 5. Device 192 is configured to forward all packets received from Port A to Port C (step 2). The Layer-2 destination address in the packet header of all these messages is the exchange's Layer-2 address. Port C, in turn, forwards all packets it received to Packet Processor 197 (step 3) that determines if the order message is valid or not. In steps 4 and 5, all valid packets processed by Packet Processor 197 are transmitted to Port B. Finally, in step 6, the packets are sent to Exchange 191. Invalid (erroneous) order messages, on the other hand, are either deleted or modified.

In one embodiment, Packet Processor 197 and Device 192 may be on the same special purpose programmable hardware device such as an FPGA. The extra delay to valid orders can be detrimental, especially considering that typically most orders are valid. It's generally acknowledged that HFTs strive for high accuracy in their order execution through eliminating the human error factor by using advanced algorithms and rigorous testing at their end.

FIG. 6a contrasts the operations of the system of invention to prior art where TAP device 192b first duplicates the incoming order messages in transmit direction. The original message whether valid or invalid is always immediately forwarded to Exchange 191, while a copy is sent to a packet processor for pre-trade checks. If an order fails the risk checks, a cancellation message is generated using an alternate protocol by the packet processor and sent to the exchange. Accordingly, TAP Device 192b directly transmits all order messages received from HFT System 193 from Port A to Port B. Then, Port B transmits packets to Exchange 191 immediately (steps 1a, 1b and 1c). Meanwhile, a copy (a clone) is generated and sent from Port A to Port C (step 2). This clone is forwarded from Port C to Port 2 of Packet Processor 197b (step 3). Packet Processor 197 b generates the cancellation request message only for invalid messages and sends them directly to Exchange Server 191 (steps 4, 5 and 6) using Port 1.

FIG. 6b illustrates a process for message flow in the reverse direction, i.e., from the exchange to the HFT. In this scenario, TAP device 192c forwards all incoming messages sourced from Exchange 191 to HFT 193 (steps 7a, 7b, and 7c). Meanwhile, a clone of all messages is sent to Port 3 of Packet Processor 197b (steps 8 and 9). The cancel confirmations using the second messaging protocol arrive at Packet Processor 197b at Port 1 (step 10). The messages originated from the exchange are using multiple protocols, including (i) status updates on valid orders including valid order executions and cancellation confirmations (i.e., those corresponding to order cancellation requests originated by the HFT) using a first messaging protocol, (ii) invalid order cancellation confirmations (i.e., those corresponding to order cancellation requests originated by Packet Processor 197b according to invention) using a second messaging protocol, and (iii) LOB updates using a third messaging protocol. Exemplary first messaging protocol is OUCH, second messaging protocol is FIX and third messaging protocol is ITCH [see ITCH Protocol Specification, NASDAQ Totalview-ITCH 5.0]. However, other combination of protocols although the name and content of the messages might be different are encompassed within the scope of this invention.

Deep Packet Inspection (DPI) that is a technique well-known in prior art and used in packet networks that examines the content of packets beyond the headers. Instead of just looking at source/destination addresses and port numbers like firewalls, switches or routers, DPI performs content inspection of the actual data contained within a packet. According to the inspected content, DPI enables different actions on the packet such as deleting, modifying, logging or passing-through. In this invention, the DPI process enables identification of message type (e.g., enter order, replace order, order rejected, etc.) and extract the content of the message.

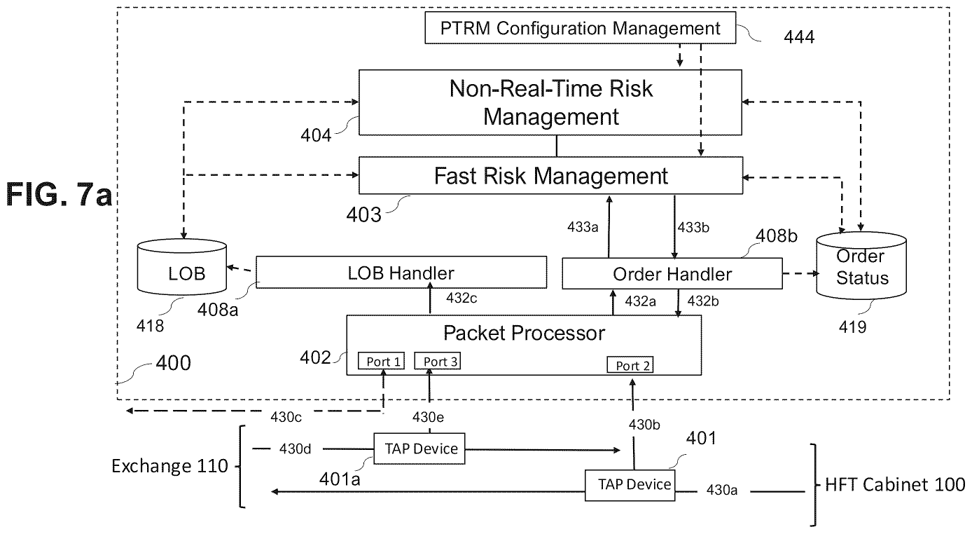

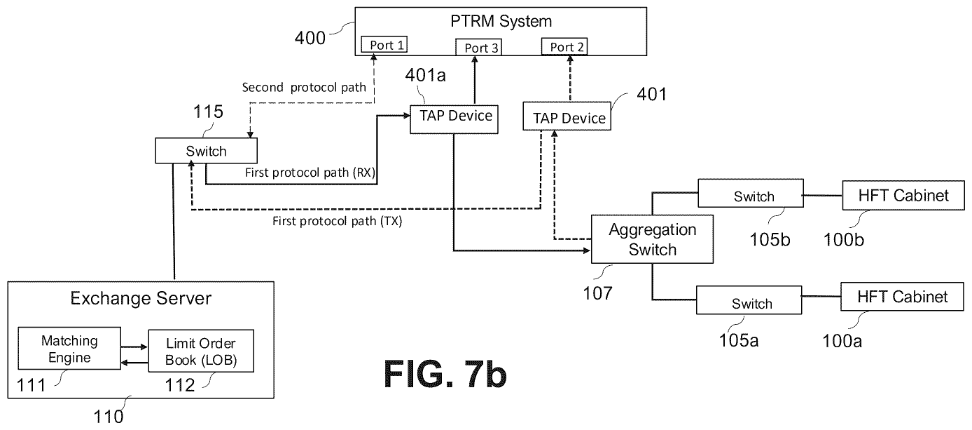

In one embodiment of the system, DPI is extensively used as shown in FIG. 7a to analyze the content of messages that flow between the of HFTs and the exchange to perform PTRM functions. To optimize performance, DPI functions are subdivided and grouped into logical blocks. Each block is designed to handle specific parts of the message, to process different message types and to perform tailored actions. For instance, the actions taken on order messages originating from an HFT differ from those actions applied to LOB updates received from the exchange or on cancel confirmation messages.

In one embodiment, system of invention 400 (aka, ‘System 400’) is connected to the data center network via an off-the shelf TAP device 401 and 401a as shown in FIG. 7a. Two TAP devices are illustrated to indicate the cloned traffic directions. In a physical implementation, these devices may be residing on the same system or may be two different systems. System 400 runs on one or more servers each with an IP address.

The colocation solution at the data center where the exchange resides uses a switched LAN between the exchange and collocated systems as illustrated in FIG. 1. Switched LAN provides layer-2 forwarding of messages through switches according to Open System Interconnection (OSI) multi-layer architecture, well known in prior art. Layer-2 and Medium Access Control (MAC) are terms used interchangeably.

In System 400, the first subfunction of DPI is labelled as Packet Processor 402 which captures and parses bidirectional traffic to extract relevant information such as packet headers, protocol types and timestamps. It is a packet traffic dispatcher, known in prior art, that performs functions of receiving, identifying and separating streams of bi-directional packet data in providing specific functions as follows:
(i) Receiving a clone of all transmit and receive side messages using a plurality of protocols.
(ii) De-multiplexing packets originated from or destined to an individual HFT from message streams.
(iii) Identifying and separating the LOB updates from messages related to orders and forwarding them for different processing components.
(iv) Sending order cancellation messages for invalid orders.

Packet Processor 402 typically has three ports. One port for order cancellations/confirmations using the second messaging protocol. One port for cloned transmit traffic, and another port for cloned receive traffic.

Next subfunction of DPI is Order Handler 408b that processes only the bi-directional order messages that it receives from Packet Processor 402 (interface 432a). These messages are order related requests that are originating from the HFT or order related responses originating from the exchange. It extracts specific fields of the order messages and sends these fields to Fast Risk Management 403 (interface 433a) for risk checks. In the meantime, all relevant order related status data is stored in Order Status 419. In one embodiment, this datastore is in-memory. Order Handler 408b also functions as a watchdog for the cancel confirmation message corresponding to cancel order message generated by System 400.

Next subfunction of DPI is LOB Handler 408a that processes only the ITCH LOB updates (interface 432c) using the third messaging protocol. This function processes the broadcasted LOB messages and updates the LOB data in LOB 418 that is an in-memory datastore.

A key subfunction of DPI is Fast Risk Management (FRM) 403 that performs pre-trade checks on the fields of received order messages and has a decision-making logic. In one embodiment, it performs the following functions:
(i) Extracting the specific PTRM risk parameters corresponding to the HFT from PTRM Configuration Management 444 and LOB data from LOB datastore.
(ii) Performing the comparison of the order message content with specific PTRM risk parameters and LOB data for risk checks.
(iii) If the order message passes the risk checks, updating order's status in Order Status 419 as ‘valid’.
(iv) If the order fails the pre-trade risk checks, updating the order's status as ‘invalid’ and initiating the order cancellation process by generating on order cancel message on behalf of the HFT using a second messaging protocol. This message is generated after an Order ID is received from the exchange using the first messaging protocol. Order ID is contained in the ‘order accepted’ message sent by the exchange. Order ID uniquely identifies a specific order in the first messaging protocol, or across first and second messaging protocols.
(v) Upon receiving a cancel confirmation response from the exchange, updating Order Status 419 as ‘cancellation completed’.
(vi) If the order passes the pre-trade risk checks, but fails the post-trade risk checks, updating the order's status as ‘invalid’ and initiating the order cancellation process by generating on order cancel message on behalf of the HFT using the steps (iv) and (v).

When Fast Risk Management 403 detects an invalid/risky order, it sends a request to Order Handler 408b (interface 433b) to process a ‘cancel order’, where: (a) the cancellation message is created, and (b) the order status is updated to ‘cancellation requested’ within Order Status 419. Following this, the Packet Processor 402 prepares the message for transmission by adding necessary packet headers upon Order Handler 408b's request (interface 432b). These headers include the source and destination addresses: a. Source: System 400's MAC and IP addresses, b. Destination: Exchange's MAC and IP addresses.

Order Status 419 tracks the state transitioning of all orders identified by Order ID and Trader ID, according to pre-trade risk management process. Exemplary states are ‘valid’, ‘pre-trade checks failed’, ‘post-trade checks failed’, ‘cancelation requested’, ‘cancellation confirmed’ and ‘cancellation failed’, etc. Other states and state names may also be used.

FIG. 7a illustrates the pathways of packet traffic originating from the HFT Cabinet 100, Exchange 110, and System 400. These pathways are for illustrative purposes only and may be implemented as internal paths within hardware components and not being exposed on physical interfaces. Paths 430a: Represents order traffic originated from the HFT that transparently passes through the tap device using the first messaging protocol. Path 430b: Represents the ‘cloned’ order traffic originated from the HFT and captured by TAP device 401 that is sent to the Packet Processor 402 for processing. This traffic follows paths 432a and 433a towards Fast Risk Management 403. Paths 403c: Represents the path of the second messaging protocol between the exchange and Fast Risk Management 403. Path 403d: Represents all packet traffic using the first messaging protocol originated from the exchange 110. Path 430e: Represents the ‘cloned’ traffic using the first messaging protocol originated from the exchange and captured by TAP device 401a that is sent to the Packet Processor 402 for processing.

PTRM Configuration Management 444 has the pre-trade and post-trade risk parameters, and functionality to record and notify the HFT on order status when pre-trade or post-trade risk checks fail. These parameters are configured by each HFT (user) manually using a GUI or electronically using an API. PTRM Configuration Management 444 may include several other PTRM related user functions.

Non-Real-Time Risk Management 404 conducts post-trade analysis on all valid order data. It leverages data from several sources: a. Order Status 419: Order status history for High-Frequency Trading (HFT), b. LOB 418: Order book data (both current and historical), and c. PTRM Configuration Management 444: User-defined risk parameters.

Utilizing this data, Non-Real-Time Risk Management 404 employs a decision-making logic to assess risks against the specified parameters. The system then generates notifications and reports. Notifications are delivered via various channels, including email and text messages to mobile devices. Reports are logged within PTRM Configuration Management 444 for the HFT's review.

In one embodiment, Non-Real-Time Risk Management 404 may invoke an order cancellation process when the order has not yet been executed by the matching engine even after the order passed the pre-trade risk checks and deemed valid by Fast Risk Management 403. These orders may be violating a PTRM parameter specified by SEC directives such as cumulative order quantity over a period. Therefore, Fast Risk Management 403 may receive an explicit request from Non-Real-Time Risk Management 404 to initiate ‘cancel order process’ for a valid order.

FIG. 7b shows how System 400, and TAP Devices 401 and 401a connect to the data center in a colocation configuration. Since System 400 is located at the sponsoring broker's site within the data center, it can support multiple collocated HFT cabinets. As illustrated, HFT Cabinets 100a and 100b are connected through Switches 105a and 105b. These switches may or may not be physically located within the cabinets. Individual cabinets may contain a variable number of servers, potentially belonging to the same or distinct HFTs.

In the first configuration, the packet traffic to/from multiple cabinets are first multiplexed by Aggregation Switch 107. This is a Layer-2 switch with many ports and larger packet forwarding capacity. When TAP Devices 401 and 401a attach to Aggregation Switch 107, it can monitor traffic coming from all HFTs located in multiple cabinets. This configuration is suitable when there are several HFT cabinets. Switches 105a and 105b are administered by a group of HFTs and responsible to forward packets in and out of the cabinet. The Aggregation Switch 107 is managed by the exchange Network Operations Center (NOC).

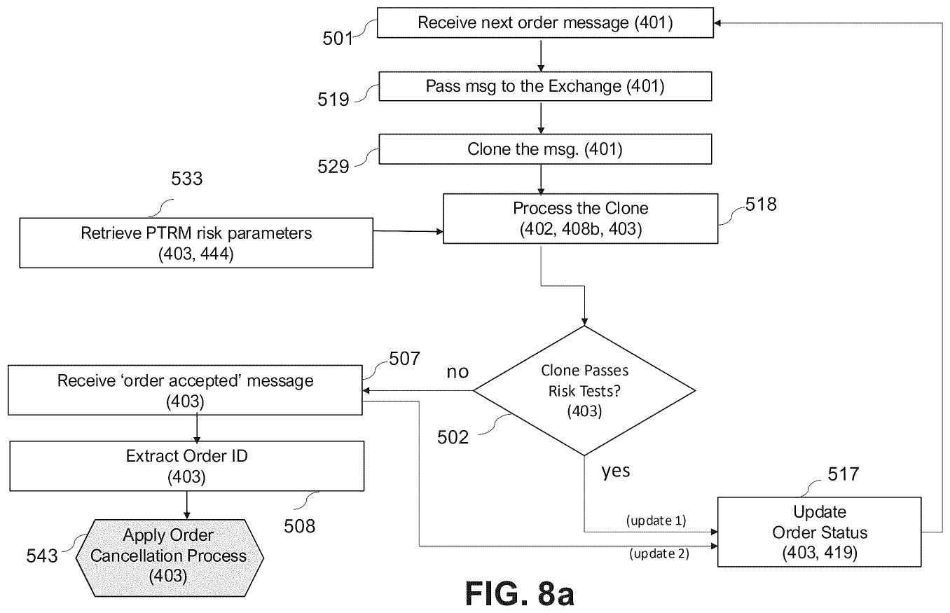

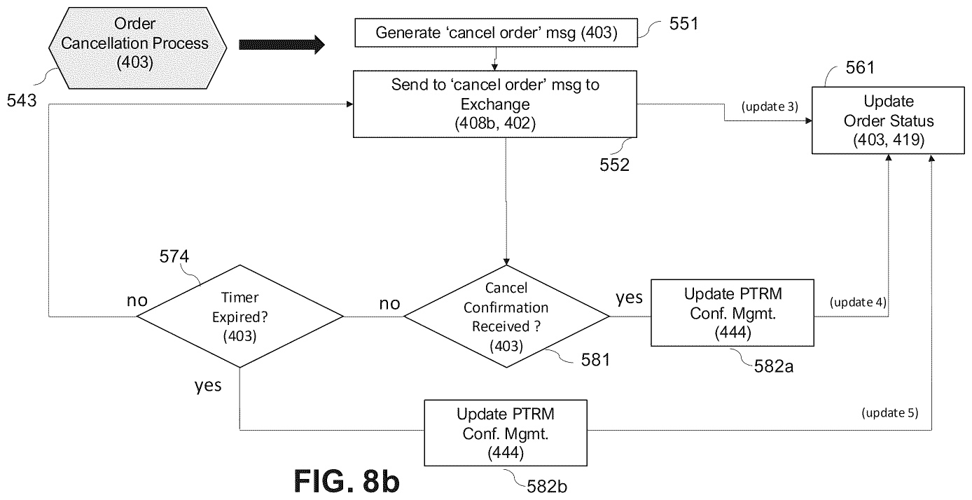

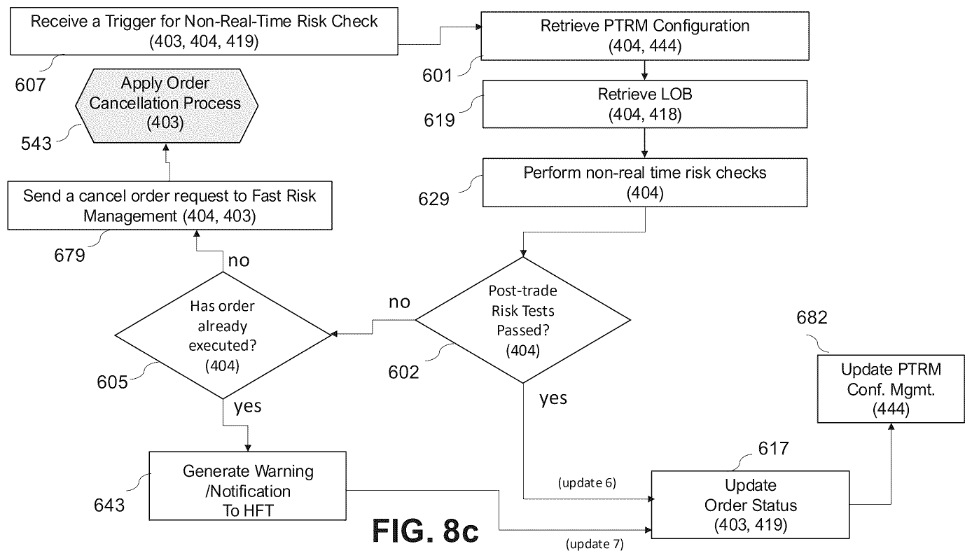

FIG. 8a and FIG. 8b illustrate pre-trade risk management process flows for the valid and invalid orders in the transmit direction (HFT to Exchange), respectively. In the valid flow scenario (FIG. 8a), Tap Device 401 receives an order message in step 501 and forwards it to Exchange 110 (step 519). A clone of the message is immediately generated (step 529) and forwarded to Packet Processor 402, Order Handler 408b, and Fast Risk Management 403 in sequence for processing (step 518).

Order related messages that do not require any risk checks such as cancel order messages initiated by the HFT do not require these steps. Any other order message (e.g., ‘enter order’ or ‘replace order’ according to OUCH protocol) that requires pre-trade risk checks goes into pipeline. Fast Risk Management 403 which retrieves the HFT's risk parameters from PTRM Configuration Management 444 and LOB data from LOB 418 (step 533). If the order message passes the checks (step 502), the order status is updated in Order Status 419 as ‘valid’ (step 517). Otherwise, order status is updated in Order Status 419 as ‘invalid’. Once ‘order accepted’ is received from the exchange (step 507), and Order ID is retrieved from the content of this message (step 508), the order cancellation process using the second messaging protocol is initiated (step 543). Note that the message and field names may change from version to version of the protocol. The term Order ID is used simply to refer to the unique identifier the exchange generates for an order.

In the invalid order flow scenario (FIG. 8b), Fast Risk Management 403 generates the content of the cancel order message by inserting the Order ID it reads from the order accepted message's content fields (step 551). The message is passed onto Order Handler 408 and Packet Processor 402 in sequence to assemble the cancel order message packets to travel down to Port 3 of Packet Processor 402 for forwarding to Exchange 110 (step 552). These packets use in the packet header fields the System 400's MAC address and IP address as source addresses and Exchange's MAC address and IP address as the destination addresses. The order status is also updated in Order Status 419 as ‘cancel requested’ (step 561). Order Status 419 may contain information other than order status for each received and processed order message such as the Order ID and Trader ID, and packet header information such as the MAC and IP addresses of the HFT and the exchange.

Fast Risk Management 403 actively monitors the status after sending the cancellation request (step 581). To ensure timely cancellation, multiple cancellation messages may be sent if the exchange's cancellation confirmation is delayed while the order is still in the LOB (step 574). If after multiple attempts, the cancellation fails, the order status is updated as ‘cancellation failed’. Upon receiving a cancellation confirmation from Exchange 110, Fast Risk Management 403 updates the PRTM Configuration Management (step 582b) recording the handling of an invalid order, and the order status as ‘cancellation confirmed’ (step 561). When the cancellation confirmation is received PTRM Configuration Management is updated (step 582a) as well as Order Status (step 561) as ‘order cancelled’.

FIG. 8c presents a representative post-trade risk management processing sequence for valid orders that have cleared pre-trade risk assessment. Upon receiving a trigger from either Order Status 419 or Fast Risk Management 403 (step 607), Non-Real-Time Risk Management (NRTRM) 404 initiates the process by retrieving the relevant PTRM configuration of the HFT generating the order (step 601) and obtaining the Limit Order Book data (step 619). Subsequent risk checks are performed, and the results are evaluated (step 629). If the risk checks succeed (checkbox 602), successful orders lead to an update of the Order Status 419 as ‘valid’ (step 617) as well as PTRM Configuration Management 444 (step 682). Conversely, for failed orders (checkbox 602) the status is updated to ‘invalid’ or ‘post-trade check failed’ while the system determines the order's execution status (step 605). If executed, a notification is generated and sent to the HFT (step 643), and the PTRM configuration is updated accordingly (step 617). For unexecuted orders, Fast Risk Management 403 is invoked to initiate the order cancellation procedure (steps 679 and 543). The rest of the procedure is executed according to steps described in FIG. 8b. In order to distinguish the ‘invalid’ state due to pre-trade checks versus post-trade checks, the system may choose to use ‘pre-trade check failed’ and ‘post-trade check failed’ states.

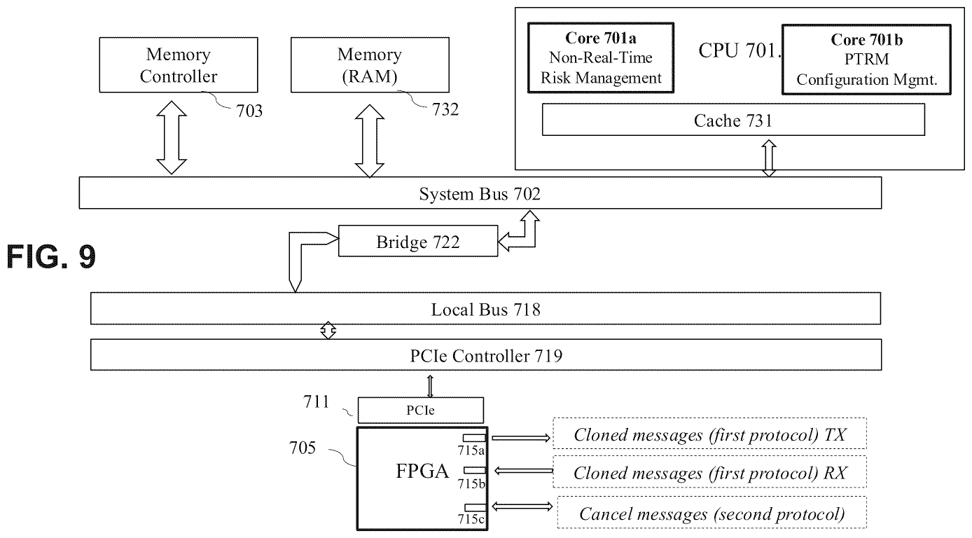

FIG. 9 depicts a simplified view of one possible embodiment of the hardware architecture of System 400 that follows the standard architecture of computer 700. This configuration employs a hybrid architecture utilizing multiple Central Processing Unit (CPU) cores and an FPGA operating concurrently. The exact number of cores and FPGAs, along with process allocation, can be customized for specific implementations. To achieve the required high performance, the system is designed by logically dividing tasks into those executed by the FPGA and the cores of the CPU. The software architecture is thereby structured into modular components, minimizing the communications required between modules to enhance performance. According to an aspect of this invention, a mixed architecture is depicted for the system utilizing both host CPU 701 with possibly multiple cores and a single FPGA. As illustrated in the diagram Packet Processor 402, Order Handler 401, LOB Handler 401b and Fast Risk Management 403 that require high-performance processing run on FPGA 705. Non-Real-Time Risk Management 404 and PTRM Configuration Management 444 components run on one or more cores 701a and 701b of host CPU 701 respectively as these components do not require strict delay in message processing. Typically, the TCP/IP stack is implemented as part of the Operating System (OS) that resides in CPU 701.

System Bus 702 is the high-speed bus that connects CPU 701 and FPGA 705 directly to Main Memory (RAM) 732 for internal data transfers. System Bus 702 carries critical data, memory addresses, and control signals. Memory Controller 703 is the component that manages communication between CPU and Main Memory 732 and/or Cache 731. In some systems, it might also handle local bus functions. Network Interfacing is achieved through the Ethernet ports of the FPGA. As illustrated, 715a and 715b are Ethernet ports (e.g., 10 Gbps) for receiving the cloned traffic in transmit (TX) and receive (RX) directions for the first messaging protocol (e.g., OUCH) and third messaging protocol (e.g., ITCH). 715c is the port to send and receive messages using the second messaging protocol. Network interfacing directly through FPGA provides significant performance improvement which impact latency. However, alternative network interfacing systems using Network Interface Cards (NICs) may achieve the same function.

Data is transferred between the CPU and the FPGA through the PCIe interface 711. Local Bus 718 connects CPU 701 and Memory Controller 703 to FPGA 705. PCIe controller 719 translates signals between Local Bus 718 and the high-speed PCIe interface that FPGA 705 uses. Bridge 722 is a central hub providing data flow between System Bus 702 and Local Bus 718 for interconnecting the CPU and other high-performance components like the FPGA. When the CPU 701 needs to interact with the FPGA, it sends a request and address information over System Bus 702. Bridge 722 receives the request and routes it to the memory controller (if memory is involved) or local bus devices. Finally, PCIe controller 719 translates the signals into the appropriate format for the high-speed PCIe interface.

In one embodiment, the present invention provides An article of manufacture having non-transitory computer readable storage medium comprising computer readable program code executable by one or more processors to perform pre-trade or post-trade risk checks, the medium comprising: (a) computer readable program code receiving a cloned order message on a first communications interface via a first messaging protocol during its transmission, the cloned order message generated by cloning an order message received from a high-frequency trading (HFT) system and destined for an exchange; (b) computer readable program code extracting one or more content fields from the cloned order message; (c) computer readable program code receiving a plurality of risk parameters associated with the HFT, and a current Limit Order Book (LOB) sent via a third messaging protocol, the plurality of risk parameters and the LOB received from one or more datastores; (d) computer readable program code comparing the one or more content fields of the cloned order message with the plurality of risk parameters and the current LOB and performing one or more risk checks; (e) computer readable program code, upon failing at least one of the one or more risk checks, generating, on behalf of the HFT, an order cancellation request message in a second messaging protocol; and (f) computer readable program code sending the order cancelation message in the second messaging protocol to the exchange over a second communications interface.

In one embodiment, the medium further comprises computer readable program code, in (e), extracting an Order ID, a unique identifier for the order to be cancelled in the order cancellation request message, received using the first messaging protocol from a cloned response message to the order cancellation request message generated by the exchange.

In one embodiment, the medium further comprises computer readable program code receiving, using the second messaging protocol, a first confirmation for the order cancellation request message, wherein the HFT also receives, using the first messaging protocol, a second confirmation for the order cancellation request message.

In one embodiment, the medium further comprises computer readable program code receiving over a third communication interface, a copy of all messages generated by the exchange using the third messaging protocol and the first messaging protocol.

In one embodiment, the third messaging protocol is a market data feed protocol providing market data information to one or more subscribers, wherein market data comprises details about all orders, trades, or market events.

In one embodiment, the first messaging protocol is a two-way order entry protocol for high-speed order management used to send orders to the exchange and receive execution updates, wherein the first messaging protocol is used to: submit new orders. replace existing orders, cancel orders, or receive execution reports.

In one embodiment, the first messaging protocol is Order Update and Cancellation History (OUCH).

In one embodiment, the second messaging protocol is Financial Information eXchange (FIX).

In one embodiment, the second messaging protocol is Representational State Transfer (REST) Application Programming Interface (API) over HTTP.

In one embodiment, the third messaging protocol is Intra-Trade Communication Handler' (ITCH).

In one embodiment, the medium further comprises computer readable program code updating order status as any of the following: (a) after passing risk checks, as ‘valid’, (b) after failing pre-trade risk checks, as ‘pre-trade check failed’, (c) after failing post-trade risk checks, as ‘post-trade check failed’, (d) after sending order cancellation request message, as ‘cancel requested’, or (e) after receiving order cancellation confirmation as ‘cancellation completed’.

In one embodiment, failure of pre-trade risk checks is because of one or more of the following types of information being wrong: stock symbol, order quantity, order price, permitted stock.

In another embodiment, the present invention provides a system that performs pre-trade or post-trade risk checks, the system comprising: (a) a memory; (b) a central processing unit (CPU) implementing pre-trade risk management (PTRM) configuration management and non-real-time risk management functions; and (c) an FPGA comprising a packet processor, a LOB Handler, an order handler and fast risk management functions, and comprising the following interfaces: (i) a first communications interfaces to connect to a first test access point (TAP) device interface to receive clones of messages originating from a high-frequency trading (HFT) system using a first messaging protocol; (ii) a second communications interface to connect to an exchange to send and receive messages using a second messaging protocol; (iii) a third communications interfaces to connect to a second TAP device interface to receive clones of messages originating from the exchange using the first messaging protocol and a third messaging protocol, wherein the memory stores computer readable computer code: (1) receiving a cloned order message on the first communications interface via the first messaging protocol during its transmission, the cloned order message generated by cloning an order message received at the HFT system and destined for the exchange; (2) extracting one or more content fields from the cloned order message; (3) receiving a plurality of risk parameters associated with the HFT and a current Limit Order Book (LOB) sent via the third messaging protocol, the plurality of risk parameters and the LOB received from one or more datastores; (4) comparing the one or more content fields of the cloned order message with the plurality of risk parameters and the current LOB and performing one or more risk checks; (e) upon failing at least one of the one or more risk checks, generating, on behalf of the HFT, an order cancellation request message in the second messaging protocol; and (f) sending the order cancelation message in the second messaging protocol to the exchange over the second communications interface.

In one embodiment of the system, the memory further stores computer readable program code to extract an Order ID, a unique identifier for the order to be cancelled used in the cancellation request message, received using the first messaging protocol from the cloned response message to the order message generated by the exchange.

In one embodiment of the system, the memory further stores computer readable program code to receive, using the second messaging protocol, a first confirmation for the order cancellation request message, wherein the HFT also receives, using the first messaging protocol, a second confirmation for the order cancellation request message.

In one embodiment of the system, the memory further stores computer readable program code to receive over a third communication interface, a copy of all messages generated by the exchange using the third messaging protocol and the first messaging protocol.

In one embodiment of the system, the third messaging protocol is a market data feed protocol providing market data information to one or more subscribers, wherein market data comprises details about orders, trades, or market events.

In one embodiment of the system, the first messaging protocol is a two-way order entry protocol for high-speed order management used to send orders to the exchange and receive execution updates, wherein the first messaging protocol is used to: submit new orders. replace existing orders, cancel orders, or receive execution reports.

In one embodiment of the system, the first messaging protocol is Order Update and Cancellation History (OUCH).

In one embodiment of the system, the second messaging protocol is Financial Information eXchange (FIX).

In one embodiment of the system, the second messaging protocol is Representational State Transfer (REST) Application Programming Interface (API) over HTTP.

In one embodiment of the system, the third messaging protocol is Intra-Trade Communication Handler' (ITCH).

In one embodiment of the system, the memory further stores computer readable program code to update order status as any of the following: (a) after passing risk checks, as ‘valid’, (b) after failing pre-trade risk checks, as ‘pre-trade check failed’, (c) after failing post-trade risk checks, as ‘post-trade check failed’, (d) after sending order cancellation request message, as ‘cancel requested’, or (e) after receiving order cancellation confirmation as ‘cancellation completed’.

In one embodiment of the system, failure of pre-trade risk checks is because of one or more of the following types of information being wrong: stock symbol, order quantity, order price, permitted stock.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Unless specifically stated otherwise, the term ‘some’ refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### Conclusion

A system and methods for ultra-low-latency pre-trade and non-real-time post-trade risk management in high-frequency trading is presented. The system analyses the clones of order messages sent from the HFT to an exchange using the first messaging protocol. If an order fails risk checks, the system automatically cancels it without the HFT's knowledge by generation order cancellation request using a second messaging protocol. This approach ensures rapid order processing while mitigating risks, without causing any delay to valid orders. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

What is claimed is:

1. An article of manufacture having non-transitory computer readable storage medium comprising computer readable program code executable by one or more processors to perform pre-trade or post-trade risk checks, the medium comprising:
a. computer readable program code receiving a cloned order message on a first communications interface via a first messaging protocol during its transmission, the cloned order message generated by cloning an order message received from a high-frequency trading (HFT) system and destined for an exchange;
b. computer readable program code extracting one or more content fields from the cloned order message;
c. computer readable program code receiving a plurality of risk parameters associated with the HFT, and a current Limit Order Book (LOB) sent via a third messaging protocol, the plurality of risk parameters and the LOB received from one or more datastores;
d. computer readable program code comparing the one or more content fields of the cloned order message with the plurality of risk parameters and the current LOB and performing one or more risk checks;
e. computer readable program code, upon failing at least one of the one or more risk checks, generating, on behalf of the HFT, an order cancellation request message in a second messaging protocol; and
f. computer readable program code sending the order cancelation message in the second messaging protocol to the exchange over a second communications interface.

2. The article of manufacture of claim 1, wherein the medium further comprises computer readable program code, in (e), extracting an Order ID, a unique identifier for the order to be cancelled in the order cancellation request message, received using the first messaging protocol from a cloned response message to the order cancellation request message generated by the exchange.

3. The article of manufacture of claim 1, wherein the medium further comprises computer readable program code receiving, using the second messaging protocol, a first confirmation for the order cancellation request message, wherein the HFT also receives, using the first messaging protocol, a second confirmation for the order cancellation request message.

4. The article of manufacture of claim 1, wherein the medium further comprises computer readable program code receiving over a third communication interface, a copy of all messages generated by the exchange using the third messaging protocol and the first messaging protocol.

5. The article of manufacture of claim 1, wherein the third messaging protocol is a market data feed protocol providing market data information to one or more subscribers, wherein market data comprises details about all orders, trades, or market events.

6. The article of manufacture of claim 1, wherein the first messaging protocol is a two-way order entry protocol for high-speed order management used to send orders to the exchange and receive execution updates, wherein the first messaging protocol is used to: submit new orders. replace existing orders, cancel orders, or receive execution reports.

7. The article of manufacture of claim 1, wherein the first messaging protocol is Order Update and Cancellation History (OUCH).

8. The article of manufacture of claim 1, wherein the second messaging protocol is Financial Information eXchange (FIX).

9. The article of manufacture of claim 1, wherein the second messaging protocol is Representational State Transfer (REST) Application Programming Interface (API) over HTTP.

10. The article of manufacture of claim 4, wherein the third messaging protocol is Intra-Trade Communication Handler' (ITCH).

11. The article of manufacture of claim 1, wherein the medium further comprises computer readable program code updating order status as any of the following: (a) after passing risk checks, as ‘valid’, (b) after failing pre-trade risk checks, as ‘pre-trade check failed’, (c) after failing post-trade risk checks, as ‘post-trade check failed’, (d) after sending order cancellation request message, as ‘cancel requested’, or (e) after receiving order cancellation confirmation as ‘cancellation completed’.

12. The article of manufacture claim 1, wherein failure of pre-trade risk checks is because of one or more of the following types of information being wrong: stock symbol, order quantity, order price, permitted stock.

13. A system that performs pre-trade or post-trade risk checks, the system comprising
a. a memory;
b. a central processing unit (CPU) implementing pre-trade risk management (PTRM) configuration management and non-real-time risk management functions; and
c. an FPGA comprising a packet processor, a LOB Handler, an order handler and fast risk management functions, and comprising the following interfaces:
i. a first communications interfaces to connect to a first test access point (TAP) device interface to receive clones of messages originating from a high-frequency trading (HFT) system using a first messaging protocol;
ii. a second communications interface to connect to an exchange to send and receive messages using a second messaging protocol;
iii. a third communications interfaces to connect to a second TAP device interface to receive clones of messages originating from the exchange using the first messaging protocol and a third messaging protocol,
wherein the memory stores computer readable computer code: (1) receiving a cloned order message on the first communications interface via the first messaging protocol during its transmission, the cloned order message generated by cloning an order message received at the HFT system and destined for the exchange; (2) extracting one or more content fields from the cloned order message; (3) receiving a plurality of risk parameters associated with the HFT and a current Limit Order Book (LOB) sent via the third messaging protocol, the plurality of risk parameters and the LOB received from one or more datastores; (4) comparing the one or more content fields of the cloned order message with the plurality of risk parameters and the current LOB and performing one or more risk checks; (e) upon failing at least one of the one or more risk checks, generating, on behalf of the HFT, an order cancellation request message in the second messaging protocol; and (f) sending the order cancelation message in the second messaging protocol to the exchange over the second communications interface.

14. The system of claim 13, wherein the memory further stores computer readable program code to extract an Order ID, a unique identifier for the order to be cancelled used in the cancellation request message, received using the first messaging protocol from the cloned response message to the order message generated by the exchange.

15. The system of claim 13, wherein the memory further stores computer readable program code to receive, using the second messaging protocol, a first confirmation for the order cancellation request message, wherein the HFT also receives, using the first messaging protocol, a second confirmation for the order cancellation request message.

16. The system of claim 13, wherein the memory further stores computer readable program code to receive over a third communication interface, a copy of all messages generated by the exchange using the third messaging protocol and the first messaging protocol.

17. The system of claim 13, wherein the third messaging protocol is a market data feed protocol providing market data information to one or more subscribers, wherein market data comprises details about orders, trades, or market events.

18. The system of claim 13, wherein the first messaging protocol is a two-way order entry protocol for high-speed order management used to send orders to the exchange and receive execution updates, wherein the first messaging protocol is used to: submit new orders. replace existing orders, cancel orders, or receive execution reports.

19. The article of manufacture of claim 13, wherein the first messaging protocol is Order Update and Cancellation History (OUCH).

20. The article of manufacture of claim 13, wherein the second messaging protocol is Financial Information eXchange (FIX).

21. The article of manufacture of claim 13, wherein the second messaging protocol is Representational State Transfer (REST) Application Programming Interface (API) over HTTP.

22. The article of manufacture of claim 16, wherein the third messaging protocol is Intra-Trade Communication Handler' (ITCH).

23. The system of claim 13, wherein the memory further stores computer readable program code to update order status as any of the following: (a) after passing risk checks, as ‘valid’, (b) after failing pre-trade risk checks, as ‘pre-trade check failed’, (c) after failing post-trade risk checks, as ‘post-trade check failed’, (d) after sending order cancellation request message, as ‘cancel requested’, or (e) after receiving order cancellation confirmation as ‘cancellation completed’.

24. The system of claim 13, wherein failure of pre-trade risk checks is because of one or more of the following types of information being wrong: stock symbol, order quantity, order price, permitted stock.
